(19) United States
(12) Patent Application Publication
(10) Pub. No.: US 2020/0186458 A1
(43) Pub. Date: Jun. 11, 2020

(54) AUTONOMOUS SYSTEM ROUTE VALIDATION VIA BLOCKCHAIN

(71) Applicant: T-Mobile USA, Inc., Bellevue, WA (US)

(72) Inventors: Paul Farag, Renton, WA (US); Andrew Watts, Seattle, WA (US); Cameron Byrne, Seattle, WA (US)

(21) Appl. No.: 16/212,543

(22) Filed: Dec. 6, 2018

(51) Int. Cl. H04L 12/755; H04L 12/749; H04L 12/715; G06F 16/182; H04L 9/06; H04L 9/08; H04L 29/12

(52) U.S. Cl. CPC H04L 45/021; H04L 45/741; H04L 45/04; H04L 2209/38; H04L 9/0643; H04L 9/0861; H04L 61/2046; G06F 16/1824

(57) ABSTRACT

In a network such as the Internet, communications between Autonomous Systems (ASes) in the network can be routed along different communication pathways. Falsely advertised ownership of an IP prefix or address by an AS can be detected by a receiving AS that receives advertisements and then checks advertised IP prefix ownership against an IP prefix registry blockchain ledger to verify whether the advertised prefix ownership is correct.

### BACKGROUND

In today's world of electronic communications, the Internet is a global network of computers where each computer that is connected to the global network must have a unique address (temporary or permanent) and different networks and subnetworks have hierarchical addresses, for example in accordance with Internet Protocol version 4 (IPv4) or Internet Protocol version 6 (IPv6).

IPv4 has 32 bit addressing, expressed as four numbers separated by dots, each number a decimal (base-10) representation of an eight-digit binary (base-2) number, for example, 217.26.60.132. A slash in an IP prefix separates an address portion (e.g., for a host within the prefix) from the number of significant bits that make up the prefix. In an example IPv4 address of 217.26.1.0/24 there are 24 significant bits in the prefix 217.26.1, and the remaining (eight) bits are for addressing hosts (such as a desktop computer) in the subnetwork identified by the prefix. An IPv4 address of 217.26.1.24 would indicate host 24 within prefix 217.26.1 (or host 1.24 in a prefix 217.26.0.0/16). From a notation-perspective, trailing zeros can be omitted so that 192.168.1.0/24 and 192.168.1/24 are logically the same.

IPv6 is similar to IPv4 but has 128 bit addressing which allows significantly more addresses. An IPv6 address is generally represented by eight groups of hexadecimal (base-16) numbers separated by colons with groups containing all zeros being optionally omitted, such as 4003:F2AC:0000:0000:0000:0000:7009:31A2 or 4003:F2AC::7009:31A2.

When a first computer wants to send a message or data packet to a second computer elsewhere on the Internet, it sends the packet including the second computer's Internet Protocol (IP) address up the hierarchical chain in the first computer's network, and further until it is ultimately routed to another network containing the second computer's IP address and then the packet filters down through that network to the second computer. In practice the network of the first computer can be a local Internet Service Provider (ISP) which in turn connects to a regional ISP, which in further turn connects to one or more large networks known as Network Service Providers (NSPs) that form the “backbones” of the Internet. The NSPs interconnect with each other via Internet Exchange Points (IXs) that are either Network Access Points (NAPs, which are publicly owned) or Metropolitan Area Exchanges (MAEs, which are privately owned). Thus the packet from the first computer would go from its ISP to a regional ISP to an NSP, and from there through an IX to one or more NSPs (backbone to backbone) and then to a regional ISP and a local ISP that hosts the second computer, finally for delivery to the second computer. For example, if the first computer had an address of 223 within a prefix 230.17.30.0/24 representing a subnet, or in other words a global IPv4 address of 230.17.30.223, and it wanted to send a message packet to 217.26.1.121 (host address 121 in the prefix 217.26.1.0/24), the message would get routed up through one or more networks owning various levels of 230.17.30.0/24 (e.g., 230.17.0.0/16, 230.0.0.0/8) and then it would be transferred (perhaps through intermediate networks owning other root prefixes) to a network owning the 217.0.0.0/8 prefix and down into the subnet 217.26.1.0/24 where it would finally be delivered to the host with address 121.

Network elements that handle the routing are called routers, which are packet switches. Routers are often connected between networks to route packets between the networks and can be found at different hierarchical levels in the Internet. Each router has a routing table of addresses and knows the subnetworks below it and their IP addresses or prefixes, but it generally doesn't know what IP addresses are hierarchically above it. Thus when a router receives an address, it looks to see if it recognizes the address. Perhaps the packet is from a first subnetwork below the router and is addressed within a second subnetwork also below the router, in which case the router could direct the packet to the second subnetwork for further delivery. If the router doesn't find the address in its routing table then it sends the packet on a default route upwards, to a next router in the hierarchy and so on until (if necessary) the packet reaches an NSP backbone. Routers connected to the NSP backbones hold the largest routing tables, and there the packet will be routed (directly or indirectly through other backbones) to a correct NSP backbone where it will then descend “downward” through smaller and smaller networks until it reaches the second computer.

Historically speaking, as the Internet expanded, tracking all routes or paths between different networks became more difficult and in response there was a transition to an Autonomous System architecture where Autonomous Systems communicate with each other using an exterior gateway protocol such as the Border Gateway Protocol (BGP) which is defined in Internet Engineering Task Force (IETF) RFC 4271 and updated in IETF RFCs 6286, 6608, 6793, 7606, 7607, 7705, and IETF Draft Standard 8212.

An Autonomous System (AS) is a collection of routers under a common administrative control, so that their IP prefixes and routing policies are harmonized and centrally controlled. Each AS determines the routing policy or policies inside its network, and the routers within it can communicate with each other using an interior gateway protocol. An AS can for example be an Internet Service Provider (ISP), a corporation, a group of corporations or companies, or a university, and can include multiple locations (IP addresses). Each AS is represented with a unique number called an ASN (Autonomous System Number) and controls a collection of connected routing prefixes that represent a block or range of IP addresses. For example, an ASN 509 can own a prefix 7.0.0.0/8.

Autonomous Systems (ASes) can pass messages to each other, and since most ASes are not connected directly with each other, they often need to route their message traffic through other, intermediate ASes before the message traffic arrives at the destination AS. For example, where multiple Autonomous Systems are located between an origin AS sending a message or data packet and an AS that is the intended destination of that message or data packet, the intervening Autonomous Systems (or ASes) route the message and hand it off from one AS to the next connected AS until the message arrives at the destination AS. Each AS notifies its neighbors of the prefixes it owns, via advertisements. Advertisements are essentially messages that an AS sends to its neighbors, that can include information the AS wants to share regarding, for example, prefixes that it owns, and prefixes that it can reach through other ASes. Thus, an AS 711 might advertise that it can hand off a message for AS 305 with the help of intervening ASes 513 and 660, such as an AS path of 711->513->660->305. By way of further example, when a first AS is located between a second AS and a third AS, the first AS can advertise to the second AS that the second AS can reach the third AS through the first AS (AS 1->AS 3). The first AS can likewise advertise to the third AS that the third AS can reach the second AS through the first AS, by sending a message to the first AS for delivery to the second AS as a final destination (AS 1->AS2). The second AS can also advertise that it connects to a fourth AS, and each AS that receives the advertisement can add its prefixes to the advertisement and send this augmented advertisement onward to other ASes that can then do the same. Thus the third AS would know that it can reach the fourth AS by sending a message to the first AS, which will send it to the second AS, which will in turn send it to the fourth AS as a final destination. In this situation the advertisement from the first AS to the third AS might be AS1->AS2->AS4. In this way ASes can learn from advertisements received from neighboring ASes about pathways to distant ASes via intermediate ASes that function as intermediate couriers or as a “bucket brigade” and can propagate advertisements that include additional pathway information to effectively build pathway maps that propagate through the network of ASes.

There can be several different kinds of relationships between ASes. In a peering relationship, ASes that are peers have a reciprocal relationship and do not charge each other for message exchange traffic. This is similar to how postal systems throughout the world transfer packages and letters—when a person in Seattle, Wash. sends a letter overseas to Beijing, China, they pay postage in Seattle to the U.S. Postal Service which then transfers the letter to the China Post, which delivers it in Beijing without further charge. A reply letter sent from Beijing would have postage paid in Beijing to the China Post and would then be delivered in Seattle by the U.S. Postal Service without additional charge. A Tier 1 Internet Service Provider (ISP) is an ISP that has access to an entire Internet region (typically, defined by a country's geographic boundaries) solely via free and reciprocal peering agreements. For example, in the US Internet Region a list of Tier 1 ISPs presently includes AT&T, Verizon, Sprint, CenturyLink/Qwest, and Level 3. A Transit relationship exists when an ISP (e.g., an AS) sells access to the Internet, agreeing to act as a router carrying traffic from one AS to another AS to which the ISP has a link, often via additional ASes through which the traffic passes in multiple transit hops. A transit ISP or AS can meter traffic on each link and charge a corresponding transit fee. A Tier 2 ISP is one that purchases Transit to connect to some or all of the Internet but may additionally establish Peer relationships with various Tier 1 and Tier 2 ASes. For example, it is not uncommon for telecom companies (cable, phone, wireless) to peer with content providers such as Google, Amazon and Microsoft. The Internet Backbone includes a collection of significant connections (routers, exchanges, etc.) that connect large ASes, such as Tier 1 ISPs, together.

### BRIEF DESCRIPTION OF THE DRAWINGS

The detailed description is described with reference to the accompanying figures. In the figures, the left-most digit(s) of a reference number identifies the figure in which the reference number first appears. The same reference numbers indicate similar or identical items.

FIG. 1 shows an illustrative computing environment and network architecture for implementing techniques to improve network communications performance between Autonomous Systems.

FIG. 2 shows illustrative details for various routers and servers/controllers within AS's in the architecture shown in FIG. 1.

FIG. 3 shows an illustrative blockchain containing chain of title information for prefixes.

FIG. 4 is a flow diagram of an illustrative process for verifying AS ownership of prefixes and acting on verification results in a network configuration such as that shown in FIG. 1.

### DETAILED DESCRIPTION

This disclosure is directed to dynamic techniques for improving flow of information between Autonomous Systems (ASes). In particular, a problem can arise when an AS falsely advertises ownership of an IP prefix (e.g., a block of IP addresses) or an IP address that it does not in fact own. False ownership of an IP prefix or address can arise not only in a unicast situation where a message or data traffic is intended to go from one machine or entity to one other uniquely identified machine or entity, but also in an anycast situation where a message or data traffic is sent to an anycast address that is an address or prefix assigned to multiple different interfaces that can belong to different nodes, machines or entities. In other words, in an anycast situation multiple physical endpoints are logically denoted or named with a single IP address or prefix, and routers that receive such an anycast communication will route it to a near or nearest one of those physical endpoints. “Nearest” in this context can mean a shortest physical path, a fastest path, a least expensive path in terms of processing or other measure, least risk of loss or mishap, or any other parameter or set of parameters that routers implementing BGP routing can take into account when routing and making routing decisions. “Near” in this context means one or more of the factors noted above, below or above one or more performance thresholds—in other words, not necessarily best, but good enough, on a correct side of the performance threshold(s). If an entity or machine falsely represents that it is one of the endpoints assigned to an anycast address or prefix, then if it is near or nearest to a router that has a message for that anycast address it will receive the message despite having no right to do so.

False ownership of IP prefixes or IP addresses can be further propagated by advertisements of other ASes that have no ill intent, because the Border Gateway Protocol (BGP) largely operates on trust in this aspect of propagating possible paths among ASes. The initial false advertisement can in some cases be based on a machine malfunction or inadvertent human error, and in other cases can arise from active malfeasance where the entity that originated the false advertisement wants to divert to itself data traffic that rightfully belongs to a different entity. Even if the intentionally misbehaving entity then routes the data traffic to its proper destination, the effects can still be harmful—for example where the misbehaving entity receives and then analyzes confidential data for purposes of furthering industrial espionage, political chicanery or financial crimes. In addition, the extra routing adds load to the common system of data exchange among ASes on the Internet and can introduce delay that disrupts or impedes business operations of entities properly relying on the hijacked data traffic. A further cost is violation of trust among business entities that can disrupt effective business processes and cause the entities to replace them with higher cost and/or lower efficiency, albeit more secure, alternatives.

To mitigate this risk of deceptive route or prefix advertising by ASes communicating with each other via BGP, a blockchain is provided that tracks rightful ownership of prefixes and can be easily and quickly accessed by ASes that receive routing and prefix advertisements, to check and verify whether the prefix ownership set forth in a given advertisement is true or false and then act accordingly.

In a network such as the Internet, communications between Autonomous Systems (ASes) in the network can be routed along different communication pathways in accordance with the Border Gateway Protocol (BGP). Falsely advertised ownership of an IP prefix or address by an AS can be detected by a receiving AS that receives advertisements and then checks advertised IP prefix ownership against an IP prefix registry blockchain ledger to verify whether the advertised prefix ownership is correct. Pathways to a falsely owned IP prefix destination can be labeled as invalid and omitted from the receiving AS'es routing tables and can be omitted from, or labeled as invalid in, advertisements sent in turn from the receiving AS. Where the falsely owned IP prefix or address is an anycast address, a different destination location that is validly associated with the anycast address can be selected for routing messages addressed to the anycast address.

Note that as used herein, “prefix” can refer to an IP prefix, but also to any prefix of a systematically hierarchical addressing system where the prefix represents a coherent block or subset of specific addresses.

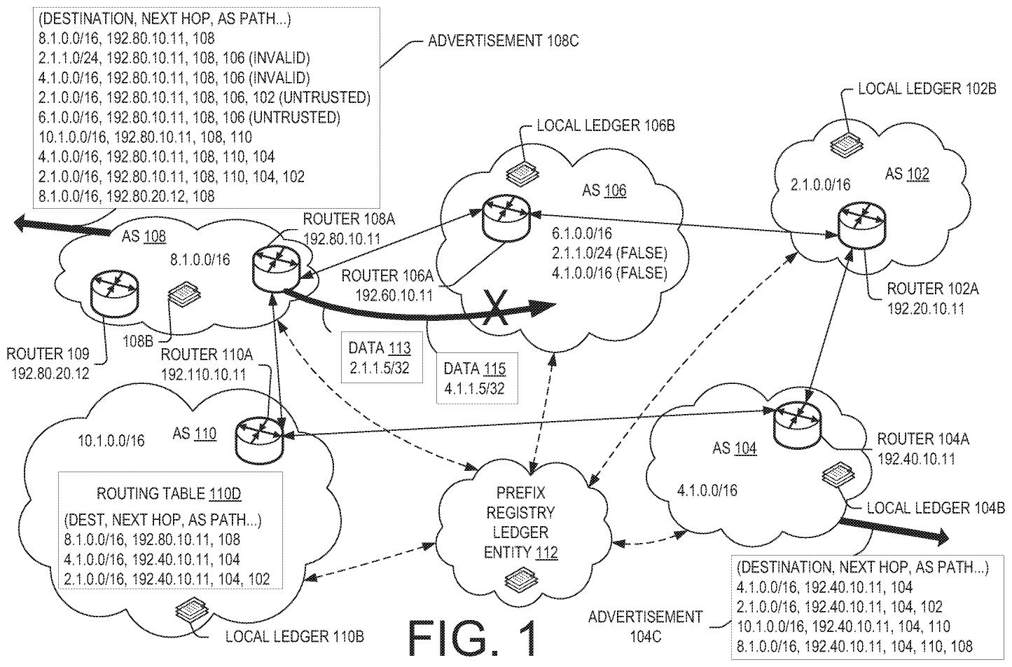

FIG. 1 shows an example system and architecture that includes a blockchain that ASes in communication with each other can use to verify routing and prefix advertisements and then route and advertise accordingly.

As shown in FIG. 1, ASes 102, 104, 106, 108 and 110 can communicate with each other and with a prefix registry ledger entity 112, and can optionally host local copies 102B, 104B, 106B, 108B, 110B of the prefix registry ledger. FIG. 1 also shows simplified examples of advertisements 108C, 104C as well as a simplified routing table 110D, and routers 102A, 104A, 106A, 108A, 110A belonging respectively to ASes 102, 104, 106, 108 and 110, as well as a router 109 belonging to AS 108. Each of the routers is shown inside its AS and with a specific address that can be provided to adjacent ASes as a next hop address, so that traffic sent to the AS having the router can go directly to the router for processing to a destination within the AS or for transit through or across the AS to a next AS in an AS path for the traffic in question. Specifically, router 108A in AS 108 has address 192.80.10.11, router 106A in AS 106 has address 192.60.10.11, router 102A in AS 102 has address 192.20.10.11, router 104A in AS 104 has address 192.40.10.11, and router 110A in AS 110 has address 192.110.10.11. The example addresses and prefixes shown in FIG. 1 are IPv4, but the principles described herein apply also to IPv6 addresses and hierarchical addressing in general.

In FIG. 1 the AS 106 is falsely advertising two prefixes, a prefix of 2.1.1.0/24 that properly belongs to AS 102, and a prefix of 4.1.0.0/16 that properly belongs to AS 104. Note that 2.1.1.0/24 is more specific than 2.1.0.0/16, and thus even though 2.1.1.0/24 lies within 2.1.0.0/16, any address or subnet within 2.1.1.0/24 (e.g., 2.1.1.220 or 2.1.1.1/25) would be routed to AS 106 instead of AS 102 because the match is more specific. If AS 108 received data traffic intended for AS 102 and data traffic intended for AS 104 and also trusted prefix advertisements from AS 106 indicating AS 106's ownership of 2.1.1.0/24 and 4.1.0.0/16, then AS 108 would send both the data packet 113 addressed to subnet 2.1.1.5/32 and the data packet 115 addressed to subnet 4.1.1.5/32, to AS 106 instead of to AS 102 and to AS 104.

However, after AS 108 receives an advertisement from AS 106 indicating that AS 106 owns prefixes 1.1.0.0/16, 2.1.1.0/24, and 4.1.0.0/16, AS 108 can check a blockchain ledger (its local ledger 108B and/or the ledger hosted by the prefix registry ledger entity 112) to verify whether the advertised ownership is correct. After receiving verification from the local ledger 108B and/or the prefix registry ledger entity 112 that AS 106 does own the prefix 6.1.0.0/16 but does not actually own the prefixes 2.1.1.0/24 and 4.1.0.0/16, the AS 108 can omit AS 106 as a destination for prefixes 2.1.1.0/24 and 4.1.0.0/16 from its internal routing table, and also from advertisements it sends to other ASes. Alternatively, AS 108 can associate those prefixes with AS 106 in AS 108's routing table and advertisements sent out to other ASes, together with a flag indicating that a path with AS 106 as the destination for 2.1.1.0/24 or 4.1.0.0/16 is invalid and/or that AS 106 does not appear to properly own prefixes 2.1.1.0.24 or 4.1.0.0/16. As yet another alternative, AS 108 can simply propagate AS 106's advertisements including (false) ownership of 2.1.1.0/24 and 4.1.0.0/16 and trust that other ASes that receive those advertisements will check the advertisements for themselves against the prefix blockchain contained in the prefix registry ledger entity 112 or other valid ledger for the prefix registry blockchain, and then route and/or advertise appropriately based on the verification results.

AS 108 can also flag, in its internal routing table and/or in advertisements sent to other ASes, that since AS 106 is falsely claiming ownership of one or more prefixes, it may not be safe to send transit traffic through AS 106 to another AS that properly owns a destination prefix of the transit traffic. In other words, if AS 106 is falsely claiming ownership of one or more IP prefixes, then perhaps it is engaged in additional nefarious activity and might be best avoided altogether. This can for example be a mechanism to shun ASes that may be generally untrustworthy. False flag plays where an AS alters an advertisement to indicate that a different AS owns a prefix that in fact it does not, to cause trouble for that different AS and/or cause destination or transit traffic to be re-routed in different paths that are advantageous to the altering AS, could be detected by comparing advertisements from different sources to discern which AS actually introduced the erroneous prefix ownership into the advertising stream.

For example, in the advertisement 108C that the AS 108 sends to other ASes adjacent to it (and not shown in FIG. 1), AS 108 properly advertises ownership of 8.1.0.0/16 together with the next hop address 192.80.10.11 of its router 109 (last entry in the advertisement) and the next hop address 192.80.10.11 of its router 108A (first entry in the advertisement). The second entry in the advertisement 108C indicates that AS 108 has a path to the prefix 2.1.1.0.24 at AS 106 via AS 108 (and the next hop, to 108, would be the address 192.80.10.11 of the router 108A in AS 108), but also indicates that this path is INVALID (e.g., because AS 106 does not actually own prefix 2.1.1.0/24). Alternatively, as noted earlier, AS 108 could pass on this path without a remark of INVALID or could omit this path from its advertisement. The third entry from the top in advertisement 108C is similar to the entry for prefix 2.1.1.0/24 with destination AS 106 and next hop address of router 108A but refers to the prefix 4.1.0.0/16 as ending at AS 106 and being invalid (because AS 104, not AS 106, properly owns prefix 4.1.0.0/16 as AS 108 discovered after querying one of the prefix registry blockchain ledgers).

The next entry in advertisement 108C is for prefix 2.1.0.0/16 and includes the next hop address of 192.80.10.11 for the router 108A in AS 108 and a valid destination of AS 102 at the end of path segment AS 108->AS 106->AS 102. But, this entry can include a flag or label of “Untrusted” or similar to indicate that although this path is valid, it passes through a transit AS (AS 106) that has made false advertisements and therefore may be generally untrustworthy and best avoided.

The next entry in the advertisement 108C is for prefix 6.1.0.0/16 and is similar to the prior entry just described in that it is valid but ends at AS 106. Even though AS 106 properly owns this destination prefix and there are no untrustworthy ASes in this path, it can still be labeled “Untrusted” as shown in order to punish AS 106 or otherwise deter future false advertising of prefix ownership. Optionally, it can be labeled as a valid path with no aspersions against AS 106. The remaining three entries in advertisement 108C not yet discussed, refer to valid paths to ASes 102, 104, 110 that route around, or do not transit, AS 106.

The advertisement 104C from AS 104 to other, adjacent ASes not shown in FIG. 1 includes an indication that AS 104 owns prefix 4.1.0.0/16, can transit traffic for prefix 2.1.0.0/16 directly to AS 102, can transit traffic for prefix 10.1.0.0/16 directly to AS 110, and can transit traffic for prefix 8.1.0.0/16 to its destination in AS 108 via an AS path of AS 106->AS 110->AS 108, all with the next hop address of 192.40.10.11 for router 104A in AS 104.

Lastly, the routing table 110D in AS 110 shows example routes or paths; a direct path to prefix 8.1.0.0/16 in AS 108 with next hop address 192.80.10.11 of AS 108's router 108A, a direct path to prefix 4.1.0.0/16 in AS 104 with next hop address 192.40.10.11 of AS 104's router 104A, and an indirect path to prefix 2.1.0.0/16 in AS 102 via AS 104 and the next hop address 192.40.10.11 of AS 104's router 104A.

Information regarding IP prefix ownership that is incorrect can be conveyed between ASes, and between an AS and another entity such as the prefix registry ledger entity 112, using the Optional Parameter field of the BGP Header defined in RFC 4271. Other mechanisms can also be used to convey information regarding prefix ownership. This information can include queries to a blockchain ledger residing in a different AS or in another third-party entity such as the prefix registry ledger entity 112, replies to the queries, information indicating invalid paths or untrusted ASes, blockchain ledger updates, and information regarding change in ownership or status of IP prefixes.

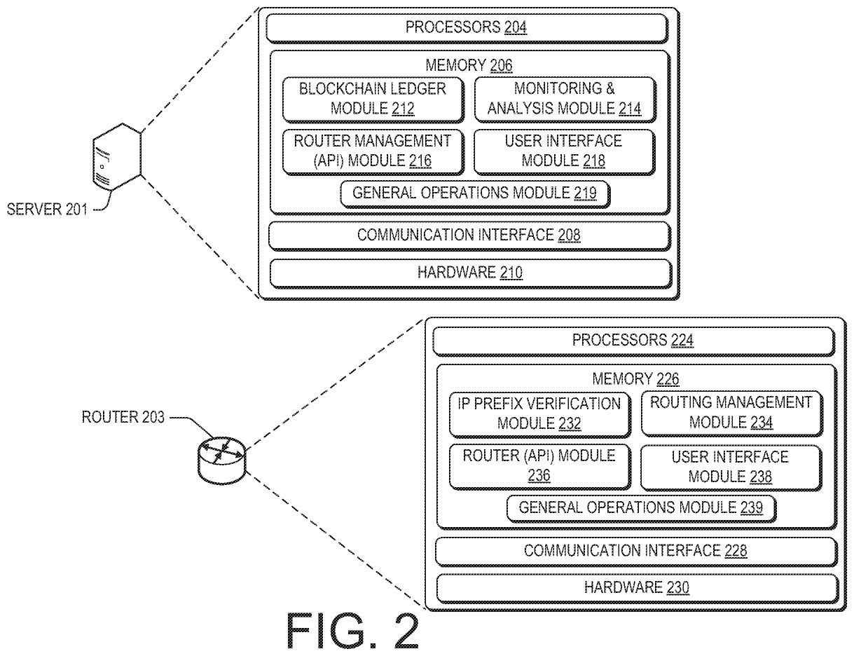

FIG. 2 shows illustrative details of a server 201 and a router 203 that can form the basis for, or be implemented as, the various routers shown in FIG. 1 and controllers or servers not shown in FIG. 1 that can support the various elements and functions described herein—for example the routers 102A, 104A, 106A, 108A, 110A, 109, functions of prefix registry blockchain ledgers, blockchain validation, and control decisions with respect to advertising and routing based on prefix ownership validation results, as variously described herein.

The server 201 includes processors 204, hardware 210, and a communication interface 208. The hardware 210 may include additional hardware interface, data communication, or data storage hardware. For example, the hardware interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices. The communication interface 208 may include wireless and/or wired communication components that enable the server to transmit data to and receive data from other networked devices. The server 201 also has a memory 206 that includes (but is not limited to) the various software modules shown. A router management API (Application Programming Interface) module 216 can facilitate communications such as command and status data between the server 201 and routers in an AS. In some embodiments the router management API module 216 can facilitate communications between the server 201 and routers in other ASes.

The server's memory 206 can also include a monitoring and analysis module 214 to support analysis of BGP data and support internal protocols within an AS and communications between ASes. The blockchain ledger module 212 can implement a prefix registry blockchain ledger within an AS, can facilitate communications with a blockchain ledger entity outside the AS such as the entity 112, and can facilitate registering transfers of IP prefixes from and/or to the AS, with a prefix registry blockchain ledger or blockchain authority outside the AS. The memory 206 additionally includes a general operations module 219 that can support various functions or tasks as required or desired to serve needs of the AS network. Functions of the modules 212, 214, 216 can be variously combined into a single module or otherwise distributed among different modules. In some embodiments, the memory 206 also includes a user interface module 218 to facilitate direct interaction with a human operator, for example for auditing or control purposes.

The router 203 includes processors 224, a communication interface 228, and hardware 230. The hardware 230 may include additional hardware interface, data communication, or data storage hardware. For example, the hardware interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices. The router 203 also includes a memory 226 that contains various software modules including an IP prefix verification module 232 that, like the module 212, supports implementation of prefix registry blockchain ledgers and/or communication with blockchain ledgers to verify IP prefix ownership. Also within the memory 226 is a routing management module 234 that supports various routing functions of the router. A router API module 236 can support communications between the router and other entities, for example the server 201, and routers belonging to the same AS or to different, neighboring ASes (for example, edge routers of an AS that are configured to interact with entities external to the AS such as other ASes, blockchain entities, and so forth). Also included are a user interface module 238 to facilitate direct communications with a human operator if needed, and a general operations module 239 that can enable the router 203 to accept and accomplish various tasks for the AS it belongs to.

The memories 206, 226 may include computer-readable storage media. Computer-readable storage media may include volatile and non-volatile, removable and non-removable media implemented in any method or technology for storage of information such as computer-readable instructions, data structures, program modules, or other data. Computer-readable storage media includes, but is not limited to, Random Access Memory (RAM), Read Only Memory (ROM), Electronically Erasable Programmable Read Only Memory (EEPROM), flash memory or other memory technology, Compact Disk Read Only Memory (CD-ROM), digital versatile disks (DVD), high-definition multimedia/data storage disks, or other optical storage, magnetic cassettes, magnetic tape, magnetic disk storage or other magnetic storage devices, or any other medium that can be used to store information for access by a computing device. As defined herein, computer-readable storage media does not consist of, and is not formed exclusively by, modulated data signals, such as a carrier wave.

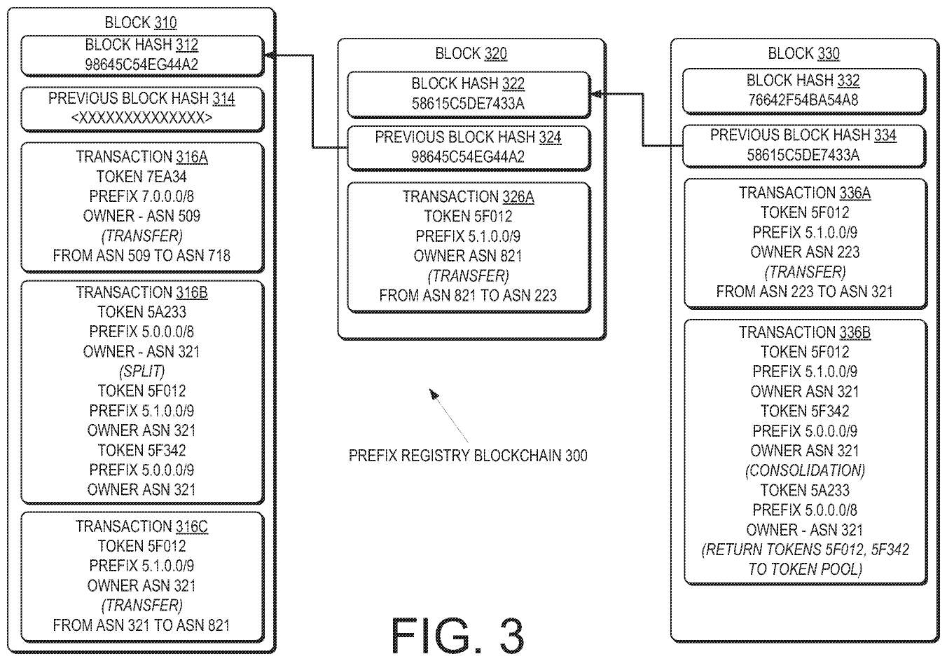

FIG. 3 illustrates an example blockchain that can be used in accordance with techniques described herein. Generally, a blockchain is a shared, distributed ledger that facilitates recording transactions and tracking assets. Blockchain architecture enables participants to share a ledger, add transactions to the ledger that are verified by a consensus algorithm of some kind, and then update distributed copies of the shared ledger to reflect a current state of the ledger. Transactions are not removed from the blockchain (although some situations can result in soft or hard “forking” where groups of copies of the ledger diverge after a particular event or transaction), only added to the blockchain so that the blockchain is a continuous chronological record of the status and provenance of assets named within it Ledgers can be public (open to all), private with participants having different levels of access to data with the blockchain, and participants can range from anonymous to well-known to each other. In a business network where participants in the ledger are granted membership and access by invitation or agreement (a private ledger), transactions can be verified and committed to the ledger (become an immutable, trusted part of the ledger) by consensus (agreement) algorithms including proof of stake (validators of a transaction own at least a percentage of the network or group's value), multi-signature (some majority of validators agree to recognize the transaction as valid), or Practical Byzantine Fault Tolerance (PBFT). PBFT is an algorithm for settling disputes between computing nodes or network/blockchain participants (in the present context, IP prefix owners for example) when one node in a set settle on a different output than other nodes in the set. Other consensus algorithms besides those enumerated above can be used.

Public blockchains such as those used by Bitcoin often use a Proof of Work consensus algorithm where validators must expend significant computing resources to solve a mathematical puzzle where the solution is easily verified—the first to solve the puzzle (which is related to a specific version of the blockchain, including a transaction or set of transactions to be memorialized into the blockchain) then “wins” and other ledgers then update their ledgers to reflect that of the winner (which includes the new block). Although Proof of Work is possible to use for constructing a blockchain for an IP prefix registry ledger, a private or semi-private network where all ASes can check the blockchain to verify ownership but only a set of ASes have rights to alter the distributed set of transactions (and perhaps see additional or detailed information relating to IP prefix ownership transactions), may advantageously use a more efficient, faster or lower cost consensus algorithm than Proof of Work.

FIG. 3 shows an example prefix registry blockchain 300 including blocks that are cryptographically linked via a hash algorithm. Specifically, a first block 310 includes transactions 316A, 316B and 316C, a hash (314) of a previous block, and a hash (312) of the current block that is a hash of a) the transactions and b) the block hash of the previous block. A hash algorithm is a function that converts a data string into a numeric string of fixed length (usually less than that of the data string), but into a number space that is dispersed so that hashes of different data strings are very rarely the same (which would be a “hash collision”). Thus the hash of the data string, or the numeric string output by the hash algorithm, can function as a fingerprint of the data string, or in this case, of the transactions and the prior block's hash. This “fingerprinting” using the hashes links the blocks together in a way that prevents any block from being altered, including insertion of another block between two existing blocks.

In the transaction 316A there is a token “7EA34” for the prefix 7.0.0.0/8 and an indication that ownership of that prefix is transferred from ASN 509 to ASN 718. Transaction 316B records splitting of a prefix 5.0.0.0/8, represented by token 5A233, into two prefixes 5.1.0.0/9 represented by a new token 5F012, and prefix 5.0.0.0/9 represented by token 5F342. The owner, ASN 321, stays the same. In transaction 316C, which is subsequent to transaction 316B, the new prefix and token 5.1.0.0/9, 5F012 are transferred from ASN 321 to ASN 821. Block hash 312 represents a hash of the transactions 316A, 316B, and 316C and also the previous block hash 314.

In a next block 320 there is one transaction 326A where the prefix 5.1.0.0/9 is transferred yet again, from ASN 821 to ASN 223 The block 320 also includes the block hash 312 of the block 310 as a previous block hash 324, and a block hash 322 that is a hash of the previous block hash 324 and the transaction 326A.

In the third block 330, in transaction 336A the prefix 5.1.0.0/9 and its token 5F012 are transferred from ASN 223 back to ASN 321, and in a next transaction 336B the prefixes 5.1.0.0/9 and 5.0.0.0/9, now both belonging to AS 321 once again, are consolidated into prefix 5.0.0.0/8 with the token 5A233 and the new tokens that were assigned to the prefixes 5.1.0.0/9 and 5.0.0.0/9 are retired and returned to a token pool maintained and administered by an IP prefix token entity. One or more organizations such as the Internet Corporation for Assigned Names and Numbers (ICANN), American Registry for Internet Numbers (ARIN), Internet Assigned Numbers Authority (IRNA), or Internet Engineering Task Force (IETF) can function as a collective token authority, managing and issuing tokens for naming IP prefixes, and prefix registry blockchain ledgers or entities can communicate directly with the collective token authority as needed, for example when an AS sends updated prefix ownership information such as that shown in FIG. 3, for registration and inclusion in the prefix registry blockchain, as can ASes owning prefixes. The block 330 also includes the block hash 322 of the block 320 as a previous block hash 334, and a block hash 332 that is a hash of the previous block hash 334 and the transactions 336A, 336B.

ASes such as the ASes 102, 104, 106, 108, 110 shown in FIG. 1 can access a prefix registry blockchain ledger to access a blockchain like the blockchain 300 to verify ownership of prefixes (e.g., 5.0.0.0/8 having token 5A233 and owned by an AS named Autonomous System Number 321) and then update router tables, route, and generate and send path advertisements accordingly. As noted further above, ASes can also communicate with a prefix registry blockchain ledger as the ledgers 102B, 104B, 106B, 108B, 110B, the prefix registry ledger entity 112, or other entity that maintains or implements the prefix registry blockchain ledger, to register changes or updates in IP prefix ownership and/or status such as splitting, consolidation and so forth.

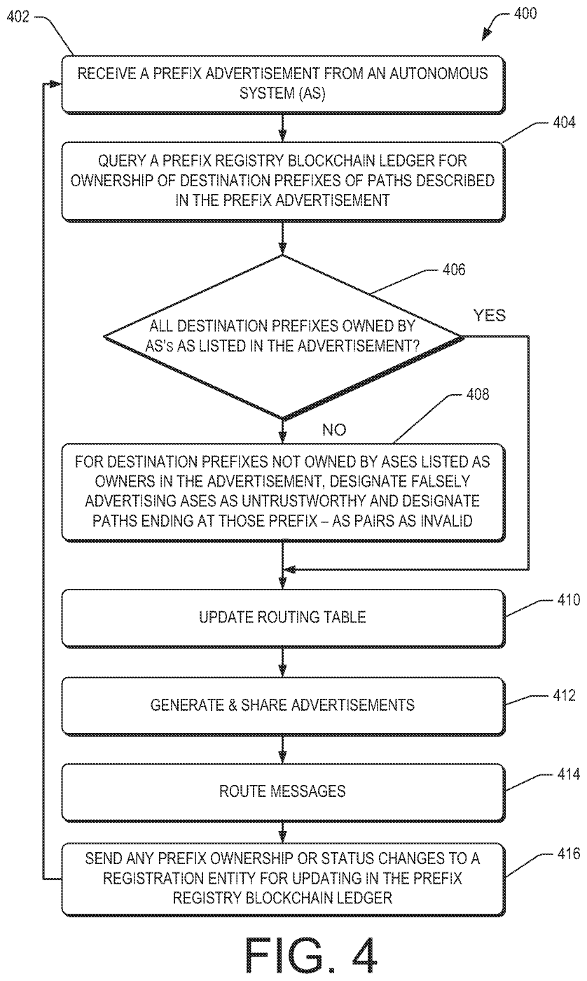

FIG. 4 is a flow diagram of an illustrative process 400 for dynamically managing, in a distributed fashion, data traffic routing among Autonomous Systems using a blockchain mechanism to verify AS ownership of prefixes. The process is illustrated from the perspective of a first AS that interacts with other ASes and can be implemented using one or more devices within the AS working separately or in concert, including routers, servers and network controllers or routers and servers having network control functions.

In a first block 402, the first AS receives a prefix advertisement from another AS, for example an AS that directly neighbors or is adjacent to the first AS, and which includes advertisements regarding IP prefixes that the neighboring AS owns, as well as other ASes and their corresponding IP prefixes that the neighboring AS can reach, directly (as in neighboring or immediately adjacent ASes) or indirectly through other, intermediate ASes. Advertisements can include, for example, anycast addresses or prefixes and corresponding ASes with physical locations associated with an anycast address.

In a next block 404, the first AS can consult a prefix registry blockchain ledger to confirm ownership of destination IP prefixes listed in the received advertisement. This can also include verifying whether a next hop address provided by an AS, is within an IP prefix properly owned by the AS or is otherwise properly owned by the AS. The ledger can be located in the first AS, can be located in another AS, or can be located in a third part entity such as the prefix registry ledger entity 112 shown in FIG. 1. In some embodiments, the first AS can consult multiple ledgers to obtain prefix ownership information.

From block 404 the process moves to block 406, where IP prefix ownership information received from the one or more blockchain ledgers consulted, is compared against prefix ownership information stated in the received advertisement. If the prefix ownership information listed in the advertisement matches ownership information received from the consulted prefix registry blockchain register, then the process moves to block 410. If any of the prefix ownership information listed in the advertisement does not match prefix ownership information received from the prefix registry blockchain ledger that the first AS queried, then the process moves to block 408.

In block 408, the first AS can pursue one or more options with respect to falsely advertised prefix ownership revealed by a query reply from the consulted prefix registry blockchain ledger. For example, false ownership can be flagged and stored within the first AS for a specified time or indefinitely (and can even be memorialized in the blockchain ledger, for example with one or more of indications of time, the false ownership including a flag that it is false, an indication of source of the false information, and correct ownership of the IP prefix in question). Alternatively, the false ownership can be ignored by proceeding as if it were true, for example treated as if it were correct for purposes of both routing and further advertising to other ASes. As a further alternative the first AS can ignore the false IP prefix ownership by presuming that the information is invalid and not placing the false information into its routing table, and by not passing the false ownership on to other ASes via advertisements. As a further alternative, the false IP prefix ownership can be marked and stored so that the false ownership can be passed on to other ASes via advertisements by way of warning. For example, destination prefix and AS pairs can be labeled as invalid destinations (thus rendering paths ending in them likewise invalid), and ASes that falsely advertise ownership of an IP prefix can be labeled as untrustworthy as destinations for IP addresses that they do in fact own, and/or for untrustworthy as transit ASes to pass message traffic to destination prefixes at other ASes. From block 408 the process proceeds to block 410.

In block 410, the first AS updates its routing tables based on the results from block 406 and block 408 as applicable. For example, correct information from the received advertisement can be used to update the routing tables, and false information can be 1) entered into the routing tables as if it were true, 2) omitted from the routing tables completely, or 3) entered into the routing tables with indications that it is false. From block 410 the process proceeds to block 412.

In block 412 the AS generates and shares advertisements, including true, verified information regarding IP prefixes and ASes that own them and corresponding message traffic paths among ASes received in advertisements as well as ownership of its own IP prefixes and paths that it can access. As described further above, the AS can pass on false information as if it were true (for example, trusting that other ASes will do their own verification of advertised information and act accordingly), can omit false information from the advertisements it sends out, or can include the false information together with warnings or indications that it is false, and that involved ASes cannot or should not be trusted as destinations for the IP prefixes in question or perhaps for other purposes (such as transit) also. From block 412 the process proceeds to block 414.

In block 414, the first AS routes message that it receives, in accordance with its routing table and chosen response to false IP prefix ownership. For example, routing as if the false IP prefix information were true, or routing only to truly owned IP prefix destinations, or routing only via (or to) ASes that truly own the IP prefixes advertised for them. In a next block 416, the first AS can register any IP prefix ownership or other IP prefix status changes, such as splitting of prefixes or combining of prefixes, to a registration entity for updating in the prefix registry blockchain ledger. From block 416, the process can return to block 402 and repeat.

Many of the functions or activities described with respect to FIG. 4 can be variously done sequentially in a different order than as shown in FIG. 4 or can be done in parallel. For example, generating and sharing advertisements, routing messages, or querying an IP prefix registry blockchain ledger, can each be done in a continuous or periodic fashion while new information is received or updated, and can use the new information as soon as it becomes available.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A network controller device, comprising:
at least one processor;
a network interface;
a storage device coupled to at least one processor;
an application stored in the storage device, wherein execution of the application by the at least one processor configures the network controller device to perform acts comprising:
receiving a prefix advertisement from an Autonomous System adjacent to a home Autonomous System containing the network controller device, the prefix advertisement including a first path comprising a first destination prefix and a first Autonomous System associated with the first destination prefix;
querying a prefix registry blockchain ledger for ownership of the first destination prefix, wherein the prefix registry blockchain ledger contains records of ownership of prefixes by Autonomous Systems; and
based on a query reply from the prefix registry blockchain ledger, determining that the first destination prefix is owned by the first Autonomous System, and storing the first path as a valid path.

2. The network controller device of claim 1, wherein the prefix advertisement includes a second path comprising a second destination prefix and a second Autonomous System associated with the second destination prefix, the acts further comprising:
determining that the second destination prefix is an anycast address and that the second Autonomous System is a destination location associated with the anycast address;
querying the prefix registry blockchain ledger for ownership of the second destination prefix;
based on a query reply from the prefix registry blockchain ledger regarding ownership of the second destination prefix, determining that the second Autonomous System does not have rights to be associated with the anycast address;
selecting a different destination location associated with the anycast address; and
routing message traffic addressed to the anycast address, to the different destination location.

3. The network controller device of claim 1, wherein the prefix advertisement includes a second path comprising a second destination prefix and a second Autonomous System associated with the second destination prefix, the acts further comprising:
querying the prefix registry blockchain ledger for ownership of the second destination prefix;
based on a query reply from the prefix registry blockchain ledger regarding ownership of the second destination prefix, determining that the second destination prefix is not owned by the second Autonomous System; and
storing the second path as an invalid path.

4. The network controller device of claim 3, the acts further comprising:
transmitting a prefix advertisement to adjacent Autonomous Systems, wherein the prefix advertisement transmitted to adjacent Autonomous Systems indicates that the second Autonomous System does not own the second destination prefix.

5. The network controller device of claim 4, the acts further comprising:
flagging the second Autonomous System as not trusted for transit operations.

6. The network controller device of claim 5, the acts further comprising:
identifying active paths from the home Autonomous System to valid destinations that transit the second Autonomous System;
selecting alternate paths to the valid destinations that do not transit through the second Autonomous System; and
routing data packets to the valid destinations along one or more of the alternate paths.

7. The network controller device of claim 3, the acts further comprising:
generating a prefix advertisement that includes valid paths received in advertisements from Autonomous Systems adjacent to the home Autonomous System with the home Autonomous System added to the valid paths, and omits invalid paths received in advertisements from Autonomous Systems adjacent to the home Autonomous System.

8. The network controller device of claim 1, wherein a description in the received prefix advertisement of the first path indicates a next hop address associated with the adjacent Autonomous System, and the acts further comprise:
querying the prefix registry blockchain ledger with respect to prefixes encompassing the next hop address; and
based on a query reply from the prefix registry blockchain ledger with respect to prefixes encompassing the next hop address, determining that the adjacent Autonomous System owns a prefix encompassing the next hop address; and
storing the next hop address as valid.

9. The network controller device of claim 1, wherein a description in the received prefix advertisement of the first path indicates a next hop address associated with the adjacent Autonomous System, and the acts further comprise:
querying the prefix registry blockchain ledger with respect to prefixes encompassing the next hop address; and
based on a query reply from the prefix registry blockchain ledger with respect to prefixes encompassing the next hop address, determining that the adjacent Autonomous System does not own a prefix encompassing the next hop address; and
storing the next hop address as invalid.

10. The network controller device of claim 1, wherein the prefix registry blockchain ledger is a ledger within the home Autonomous System.

11. A method for operating a network, comprising:
receiving at a home Autonomous System a prefix advertisement from an Autonomous System adjacent to the home Autonomous System, the prefix advertisement including a first path comprising a first destination prefix and a first Autonomous System associated with the first destination prefix;
querying a prefix registry blockchain ledger for ownership of the first destination prefix, wherein the prefix registry blockchain ledger contains records of ownership of prefixes by Autonomous Systems; and
based on a query reply from the prefix registry blockchain ledger regarding ownership of the first destination prefix, determining that the first destination prefix is owned by the first Autonomous System, and storing the first path as a valid path.

12. The method of claim 11, wherein the prefix advertisement includes a second path comprising a second destination prefix and a second Autonomous System associated with the second destination prefix, the method further comprising:
determining that the second destination prefix is an anycast address and that the second Autonomous System is a destination location associated with the anycast address;
querying the prefix registry blockchain ledger for ownership of the second destination prefix;
based on a query reply from the prefix registry blockchain ledger regarding ownership of the second destination prefix, determining that the second Autonomous System does not have rights to be associated with the anycast address;
selecting a different destination location associated with the anycast address; and
routing message traffic addressed to the anycast address, to the different destination location.

13. The method of claim 11, wherein the prefix advertisement includes a second path comprising a second destination prefix and a second Autonomous System associated with the second destination prefix, the method further comprising:
querying the prefix registry blockchain ledger for ownership of the second destination prefix;
based on a query reply from the prefix registry blockchain ledger regarding ownership of the second destination prefix, determining that the second destination prefix is not owned by the second Autonomous System; and
storing the second path as an invalid path.

14. The method of claim 13, further comprising:
transmitting a prefix advertisement to adjacent Autonomous Systems, wherein the prefix advertisement transmitted to adjacent Autonomous Systems indicates that the second Autonomous System does not own the second destination prefix; and
flagging the second Autonomous System as not trusted for transit operations.

15. The method of claim 14, further comprising:
identifying active paths from the home Autonomous System to valid destinations that transit the second Autonomous System;
selecting alternate paths to the valid destinations that do not transit through the second Autonomous System; and
routing data packets to the valid destinations along one or more of the alternate paths.

16. The method of claim 13, further comprising:
generating a prefix advertisement that includes valid paths received in advertisements from Autonomous Systems adjacent to the home Autonomous System with the home Autonomous System added to the valid paths, and omits invalid paths received in advertisements from Autonomous Systems adjacent to the home Autonomous System.

17. One or more computer-readable storage media storing instructions that, when executed by one or more processors, cause the processors to perform acts comprising:
receiving at a home Autonomous System a prefix advertisement from an Autonomous System adjacent to the home Autonomous System, the prefix advertisement including a first path comprising a first destination prefix and a first Autonomous System associated with the first destination prefix;
querying a prefix registry blockchain ledger for ownership of the first destination prefix, wherein the prefix registry blockchain ledger contains records of ownership of prefixes by Autonomous Systems; and
based on a query reply from the prefix registry blockchain ledger regarding ownership of the first destination prefix, determining that the first destination prefix is owned by the first Autonomous System, and storing the first path as a valid path.

18. The one or more computer-readable storage media of claim 17, wherein the prefix advertisement includes a second path comprising a second destination prefix and a second Autonomous System associated with the second destination prefix, the acts further comprising:
determining that the second destination prefix is an anycast address and that the second Autonomous System is a destination location associated with the anycast address;
querying the prefix registry blockchain ledger for ownership of the second destination prefix;
based on a query reply from the prefix registry blockchain ledger regarding ownership of the second destination prefix, determining that the second Autonomous System does not have rights to be associated with the anycast address;
selecting a different destination location associated with the anycast address; and
routing message traffic addressed to the anycast address, to the different destination location.

19. The computer-readable storage media of claim 17, wherein the prefix advertisement includes a second path comprising a second destination prefix and a second Autonomous System associated with the second destination prefix, the acts further comprising:
querying the prefix registry blockchain ledger for ownership of the second destination prefix;
based on a query reply from the prefix registry blockchain ledger regarding ownership of the second destination prefix, determining that the second destination prefix is not owned by the second Autonomous System;
transmitting a prefix advertisement to adjacent Autonomous Systems, wherein the prefix advertisement transmitted to adjacent Autonomous Systems indicates that the second Autonomous System does not own the second destination prefix;
flagging the second Autonomous System as not trusted for transit operations;
identifying active paths from the home Autonomous System to valid destinations that transit the second Autonomous System;
selecting alternate paths to the valid destinations that do not transit through the second Autonomous System; and
routing data packets to the valid destinations along one or more of the alternate paths.

20. The computer-readable storage media of claim 19, the acts further comprising:
generating a prefix advertisement that includes valid paths received in advertisements from Autonomous Systems adjacent to the home Autonomous System with the home Autonomous System added to the valid paths, and omits invalid paths received in advertisements from Autonomous Systems adjacent to the home Autonomous System.
